(19) United States
(12) Patent Application Publication
(10) Pub. No.: US 2015/0043054 A1
(43) Pub. Date: Feb. 12, 2015

(54) ADAPTIVE OPTICS FOR COMBINED PULSE FRONT END PHASE FRONT CONTROL

(71) Applicant: ISIS INNOVATION LTD, Oxfordshire (GB)

(72) Inventors: Martin Booth, Oxfordshire (GB); Patrick Salter, Oxfordshire (GB); Richard Simmonds, Oxfordshire (GB)

(21) Appl. No.: 14/386,396

(22) PCT Filed: Mar. 19, 2013
(86) PCT No.: PCT/GB2013/050712

§ 371 Date: Sep. 19, 2014

(30) Foreign Application Priority Data
Mar. 20, 2012 (GB) 1204846.8

(51) Int. Cl. H01S 3/00; G02F 1/01; G02B 26/06; G02B 27/09

(52) U.S. Cl. CPC H01S 3/0057; G02B 27/09; G02F 1/01; G02B 26/06
USPC 359/291; 359/298; 359/238

(57) ABSTRACT

In a method and system for controlling the shape of an optical pulse, the two-dimensional shape of the phase front is controlled using a first control device and the shape of the phase front and the two-dimensional shape of the pulse front is controlled using a second control device. The combined effect on the phase front results in a desired overall phase front control and the second device provides the desired overall pulse front control. This enables the phase front control and pulse front control to be decoupled. Correcting for pulse lengthening of femtosecond laser pulses during focusing by a dispersive lens. The spatially varying phase (72) introduced by the lens can be corrected for by a spatial light modulator like (SLM) a liquid crystal modulator. The spatially varying arrival time at the focus (70) can be compensated for by a deformable mirror (DM). A controller with a feedback loop and pulse characterization in the focus can compensate for the errors introduced by any dispersive focusing means.

This invention relates generally to the shaping of a light beam, and particularly relates to the shaping of the pulse front and phase front of an ultrashort laser pulse.

Mode locked lasers produce so-called ultrashort pulses, which may be as short as a few tens of femtoseconds in duration. An ultrashort laser pulse may be considered to relate to pulses of less than 200 fs duration, and this invention relates particularly (but not exclusively) to those in the range of approximately 50-100 fs duration, which corresponds to a spectral bandwidth of approximately 10-20 nm. These values are typical of the widely used titanium-sapphire oscillators, which operate at wavelengths between 650-1100 nm, but most commonly around 800 nm.

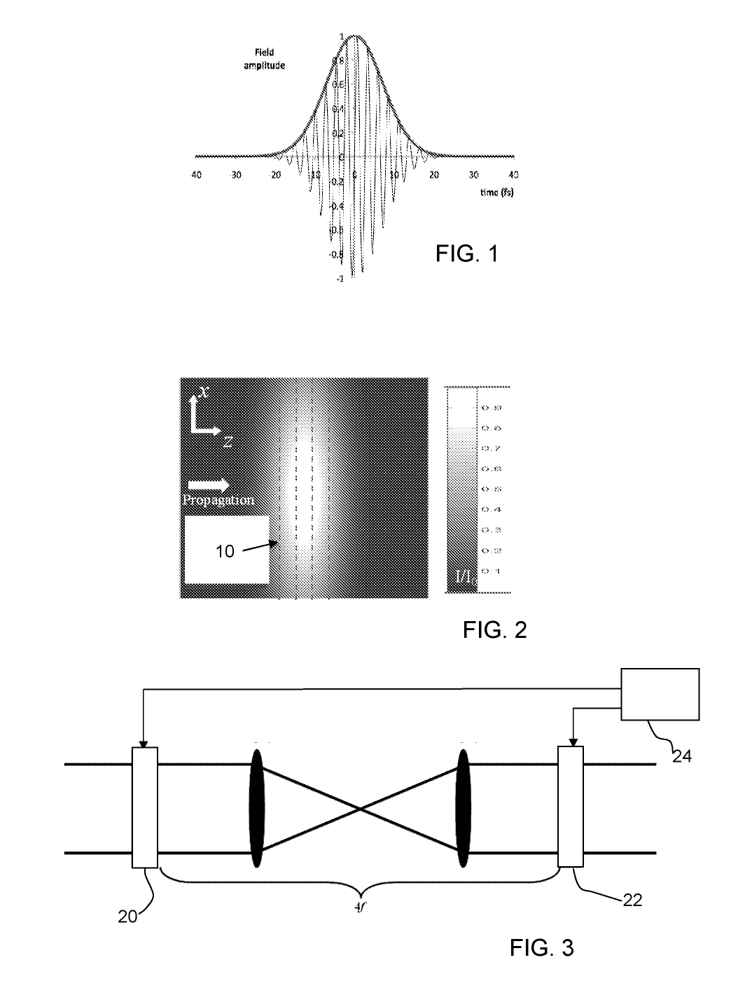

When there is a constant phase for all spectral components, the pulse is said to be time-bandwidth limited and has the shortest possible duration. It is the superposition of many modes lasing at slightly different wavelengths across the bandwidth that generates an ultrashort pulse. In practice, the electric field can be considered as a wave oscillating at central frequency of the pulse ω₀ multiplied by an envelope function, which describes the temporal decay in amplitude of the field away from the centre of the pulse. This is shown in FIG. 1.

In free space, the pulse propagates at the speed of light c. In other media, the pulse and the field oscillations may travel at velocities different to c. The term “phase front”, or equivalently termed “wave front”, describes contours of constant phase and the term “pulse front” describes contours of constant intensity across a beam.

In FIG. 2, the pulse front is visible as the bright band, and the phase front is schematically represented by the dotted lines 10. The sequence of phase front lines represent successive periods of the waves. For the pulse durations of interest, the physical length of the pulse is around 30 μm (3×10⁸ m/s×100 fs), with a wavelength (and thus distance between the phase front lines) of 800 nm for example.

Thus, the phase front relates to the oscillating electric (or magnetic) field while the pulse front relates to the envelope function. In a medium of refractive index n, the phase front travels at the phase velocity (vₚ=c/n), while the pulse front travels at the group velocity (v_{g}=δω/δk, where ωis the angular frequency and k is the wavenumber). In the presence of dispersion, vₚ≠v_{g} and the pulse front and phase fronts travel at different speeds. Dependent on the optical components and their configuration in a particular system, the pulse front and phase front are also not necessarily parallel across a beam.

The control of the shape of ultrashort laser pulses is of particular interest, for example to provide lens correction in systems using ultrashort pulses, in microscopy and in fabrication systems using ultrashort pulses. However, the interaction between the phase front and the pulse front makes this control a challenge.

According to the invention, there is provided a method and system as claimed in the independent claims.

In one aspect, the invention provides a method of controlling the shape of an optical pulse, comprising:
controlling the shape of the phase front of the pulse across a two dimensional area using a first control device which does not significantly alter the pulse front shape;
controlling the shape of the phase front and the shape of the pulse front across a two dimensional area using a second control device;
wherein the first and second devices are controlled such that the combined effect on the phase front results in a desired overall phase front control and the second device provides a desired overall pulse front control.

This method uses two pulse shaping devices, to provide a dual adaptive optics approach. By using one device which controls only the phase, and another which controls the phase and pulse front, the spatial control of the pulse front and the phase front are decoupled. This enables the method to provide independent control of the pulse front and phase front. The method is of particular interest for an ultrashort pulsed laser beam, by which is meant a duration of less than 200 fs.

The method can comprise imaging the first control device onto the second control device using an optical lens system. This makes the two control devices operate in conjugate planes, so that the phase control implemented by the two control devices is superposed. The lens system can be a 4 f optical system.

It is noted that the optical pulse can be processed by the two control devices in either order; the device named above as the “first control device” does not necessarily process the pulse first.

By way of example, the first control device can comprise a liquid crystal phase-only spatial light modulator or a pixellated mirror device. The second control device can for example comprise a membrane deformable mirror.

In another aspect, the invention also provides a system for optical pulse shaping of an optical pulse, comprising:
a first control device for controlling the shape of the phase front of the pulse across a two dimensional area which does not significantly alter the pulse front shape;
a second control device for controlling the shape of the phase front and the shape of the pulse front across a two dimensional area; and
a controller, which is adapted to control the first and second devices such that the combined effect on the phase front results in a desired overall phase front control and such that the second device provides a desired overall pulse front control.

This system enables the independent control of the phase front and pulse front shape as outlined above.

Examples of the invention will now be described in detail with reference to the accompanying drawings, in which:

FIG. 1 shows an ultrashort pulse;

FIG. 2 shows the pulse front and phase front of the pulse;

FIG. 3 shows in schematic form an example system of the invention;

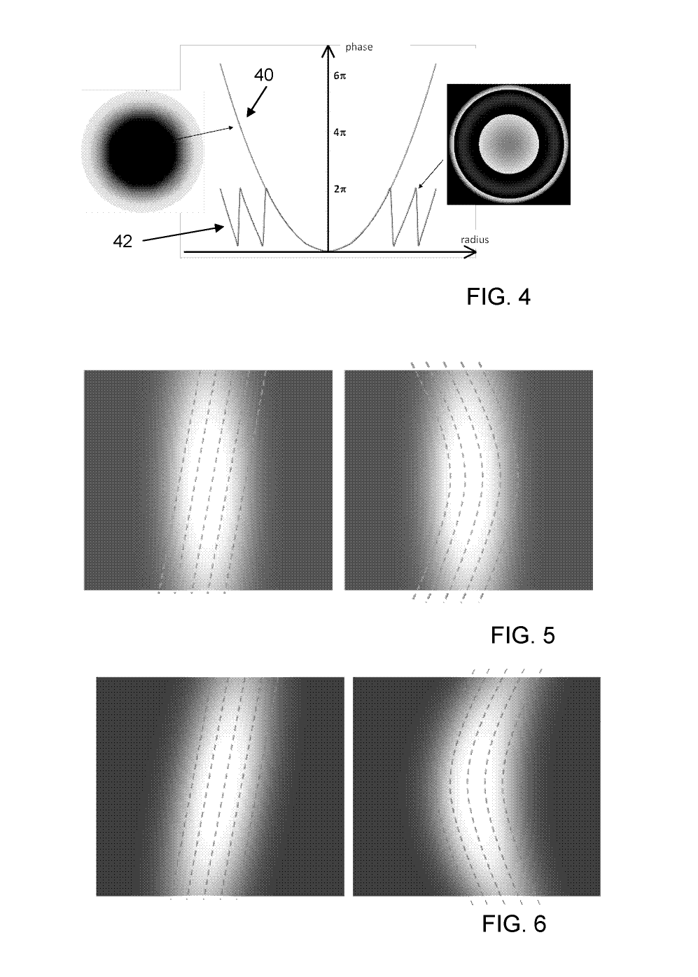

FIG. 4 shows how the phase control implemented by the different parts of the system of FIG. 3 differ;

FIG. 5 shows two different phase shaping functions that can be implemented by the invention;

FIG. 6 shows two different pulse front shaping functions that can be implemented by the invention;

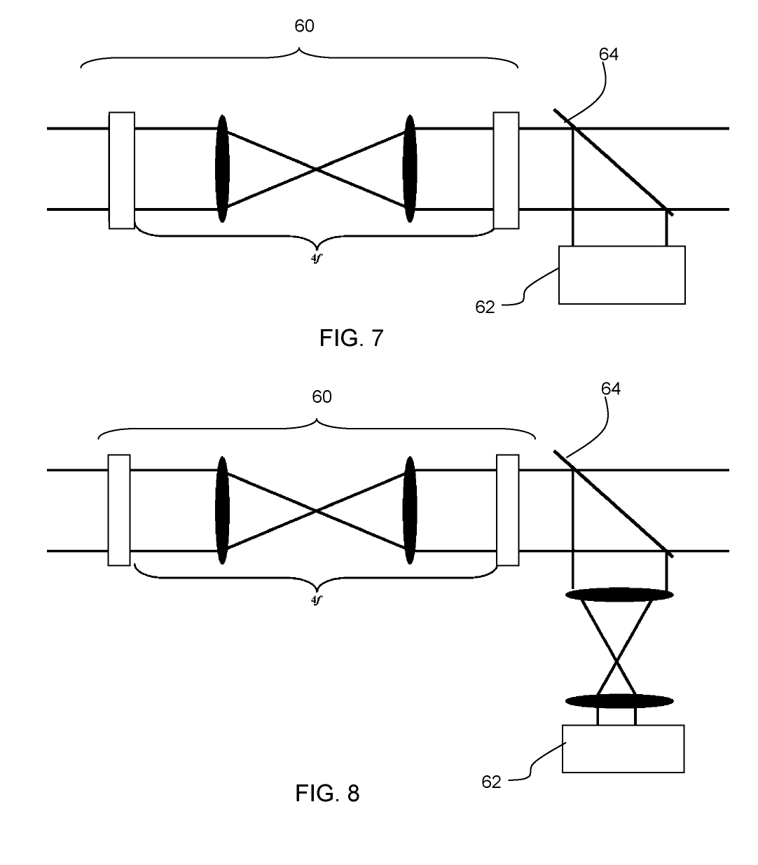

FIG. 7 shows a first example of how the system of the invention can be provided with a pulse measurement system;

FIG. 8 shows a second example of how the system of the invention can be provided with a pulse measurement system;

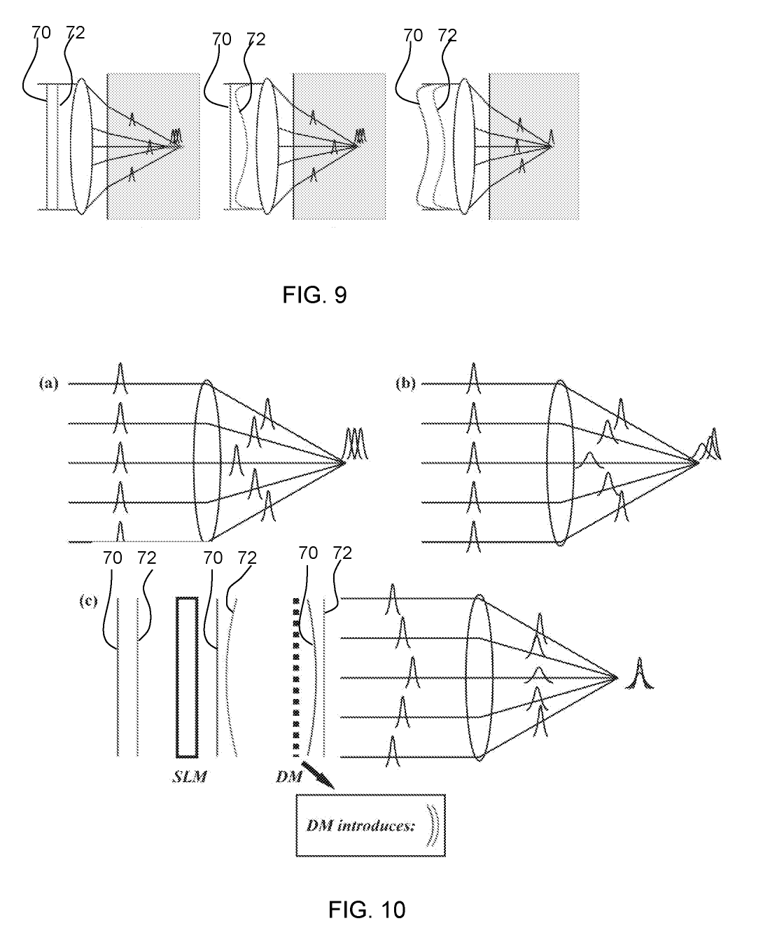

FIG. 9 shows how the invention can be used to enable compensation for lens focusing across a refractive index boundary;

FIG. 10 shows how the invention can be used to correct for pulse front distortion;

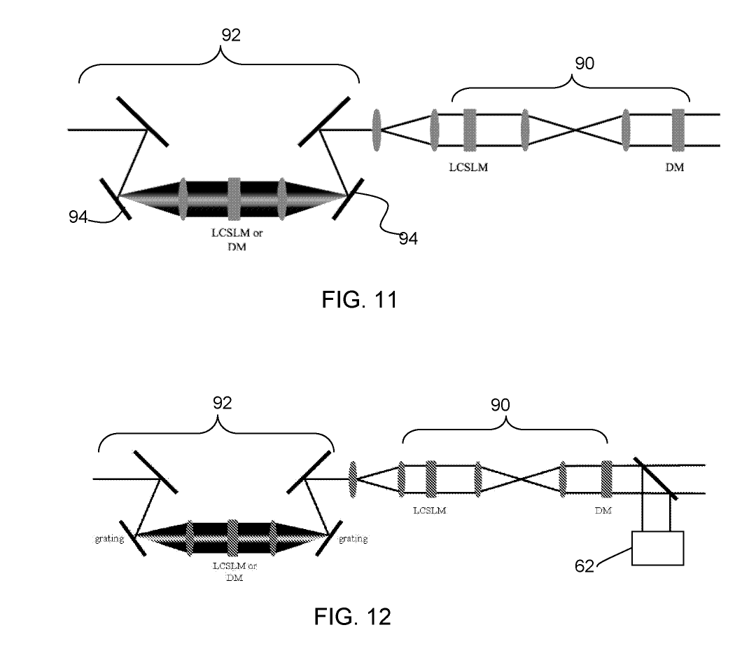

FIG. 11 shows the addition of spectral pulse shaping to the system of the invention; and

FIG. 12 shows the addition of spectral pulse shaping to the system of the invention as well as a pulse measurement system.

The invention provides a method (and system) for controlling the shape of an optical pulse in which the shape of the phase front (in 2D) is controlled using a first control device and the shape of the phase front and the shape of the pulse front is controlled (in 2D) using a second control device. The combined effect on the phase front results in a desired overall phase front control and the second device provides the desired overall pulse front control. This enables the phase front control and pulse front control to be decoupled.

FIG. 3 shows in schematic form an example of the system of the invention.

The system is for shaping a laser pulse. The laser pulse can propogate from left to right or right to left with respect to the components in FIG. 3.

The laser pulse typically has a duration of around 100 fs (or more generally less than 200 fs and typically more than 10 fs), which corresponds to a physical length in free space of 30 μm. The wavelength can be around 800 nm (or more generally greater than 300 nm and less than 1500 nm). The laser output for example has a cross sectional diameter of 1 mm. This is expanded by expanding optics (not shown) so that the beam can be processed by two-dimensional control devices, with typical linear dimensions of around 15 mm.

A first control device 20 is for controlling the shape of the phase front of the pulse across the dimensional area but it does not significantly alter the pulse front shape.

A second control device 22 is for controlling the shape of the phase front and the shape of the pulse front across the two dimensional area.

The two control devices are imaged onto each other by a 4 f optical system, of two cascaded lenses with a common focus at the Fourier plane. This optical system means the two control devices are in conjugate planes. The first device can also be magnified or de-magnified to appropriately fit the size of the second device (or vice versa) using this optical system.

A controller 24 is used to control the first and second control devices 20,22 such that the combined effect on the phase front results in a desired overall phase front control and such that the second device provides a desired overall pulse front control. The optical system of the invention makes use of known optical modules, and there are various possible examples. A first example uses a liquid crystal phase-only spatial light modulator (SLM) as the first control device 20 and a deformable mirror (DM) such as a membrane deformable mirror as the second control device 22. One example of SLM comprises a reflective structure, for example formed as a pixellated array of 600×800 pixels in a 12 mm×16 mm grid. The SLM alters the phase front of an incident wave. The maximum phase difference generated by the liquid crystal medium is 2π radians at each pixel, but phase patterns of larger amplitude may be imposed on a phase front by “wrapping the phase” from 2π→0 between adjacent pixels. Wrapping the phase across the pupil takes advantage of the degeneracy between 0 and 2π for a wave. More generally, control device 20 can be any device that adapts the phase of the wavefronts and utilises phase wrapping for any phase changes greater than an absolute value of 2π radians.

The effect on the pulse front is negligible (maximum delay=λ/c=800 nm/c≈3 fs) with respect to the pulse widths (≈100 fs) under consideration. Therefore the pulse front can be assumed to remain uniform after reflection from the SLM.

The DM can for example comprise a membrane suspended over an array of electrostatic control devices, each driven by a respective actuator. In one example, the DM can be circular with a diameter of 15 mm, with a set of 52 actuators (an 8×8 grid with the 3 pins removed from each corner). A DM is capable of large amplitude continuous phase changes. The DM can have a continuous reflective membrane, although segmented MEMS mirrors are also possible. Thus, a wide range of DM devices are commercially available. More generally, control device 22 can be any device that adapts both the phase of the wavefronts and the optical path length across the wavefront, so modifying the pulse front. For this capability, the device must have a range of travel that is at least several times larger than the wavelength of the laser light.

The DM is capable of producing continuous shapes with large amplitudes, although with a lower spatial resolution and precision than the SLM. Therefore, while the SLM only modulates the phase front in the range 0 to 2π radians, the DM is capable of changing the full optical path length over a range of many wavelengths. Thus shapes can be applied that introduce a change to both the phase front and the pulse front.

FIG. 4 shows how the DM and SLM influence the phase of the pulse. The SLM phase function 42 cycles in a discontinuous manner between 0 and 2π The maximum signal delay is thus one wavelength, so that the pulse front is not significantly affected. The DM has a continuous function 40.

By matching the shapes of the phase functions, the phase changes can be completely cancelled so that the combined system can be used to provide pulse front control only. In particular if the phase functions are equal and opposite, then they can cancel out. Alternatively, the combined effect of the two phase functions can result in a desired phase pattern. Thus, by using the two devices in conjugate planes, it is possible to decouple the pulse front and the phase front, and apply distinct spatial control to each.

FIG. 5 shows how the SLM can be used to spatially modulate the phase front (the dotted line) across the beam, but to a good approximation has no effect on the pulse front. This is shown by the unchanged brightness pattern. The left image shows a phase front tilt and the right image shows a radially dependent phase front.

As shown in FIG. 6, the DM modifies both the pulse front and the phase front. Again, the left image shows a pulse and phase front tilt and the right image shows a radially dependent phase and pulse front.

The controller 24 in FIG. 3 is used to configure the two controllers. For this purpose, the controller 24 can be considered to include the driver circuitry for each controller and additional control logic which is used to set the drive conditions for each controller based on the desired pulse shaping function. The desired pulse shaping function is input to the controller by the user, together with other parameters which relate to the apparatus, such as the type of lenses, the optical media through which the pulses will propagate, etc.

The deformable mirror device has a lower spatial resolution and is thus less accurately controllable. Thus, if the phase front is to be unchanged, then the SLM is controlled to copy an inverse of the phase front function of the DM. This is shown in FIG. 4, where the shape of the SLM function if unwrapped matches the DM function.

In one implementation, the controller 24 sets the desired pulse front function to be implemented by the DM, and then derives the required phase front function to be implemented by the higher resolution SLM in order to achieve a desired overall phase front function.

The desired overall function may be arbitrary, a radial phase function, a linear phase function such as phase tilt, or no phase control so that purely pulse front control can be implemented. The pulse front control implemented by the DM results from the physical distances involved. With a physical pulse width of 30 μm (as explained above), the physical movement of a mirror device can provide the required change in path length to implement pulse shape control.

Various control methods can be implemented by the system. In one set of examples, a form of pulse measurement system can be integrated into the system. An example of a simple system is shown in FIG. 7 where a pick off from the beam is placed after the pulse front control system 60 of the invention. A partial reflector is shown as 64 and this provides a signal to a wavefront/pulse characterisation unit 62. This is used to monitor the temporal/spectral and spatial characteristics of the pulse. The pulse characterisation could be implemented as a standard autocorrelator, or variants of commercial devices such as the FROG (Frequency Resolved Optical Gating) or SPIDER (Spectral Phase Interferometry for Direct Electric-field Reconstruction) specifically designed for ultrashort pulse measurements.

Another form of characterisation that can be implemented following the pulse front controller 60 is a wavefront sensor, such as a Shack-Hartmann device, interferometer or phase diversity measurement to determine the output wavefront. Measurements from the characterisation module 62 in FIG. 7 can then be used to feed information back into the pulse front control system and optimise the output pulse.

For certain wavefront sensors (WFS) it might be required to image the plane of the DM (or more generally the second control device) onto the input plane of the WFS as shown in FIG. 8, in which an optical lens arrangement is provided between the partial reflector 64 and the characterisation module 62.

There are variants on the implementation of the pulse front control scheme. Essentially, there is a first adaptive element that is capable of modifying only the phase front coupled to a second adaptive element that modifies both the phase and pulse front. The devices can be in either order. One possible alternative implementation is to use a large amplitude range continuous DM in conjunction with a segmented DM with a smaller range but capable of phase wrapping. Thus both devices can be implemented as deformable mirrors, one with limited change to the path length and using phase wrapping.

It is noted that SLMs and DMs are well known.

Traditionally SLMs and DMs have been used to spatially modify phase fronts of ultrashort pulses in microscopy and laser fabrication for aberration correction and holographic patterning of the intensity distribution in the focal volume. This is normally done with little regard to the effect on the pulse front. Alternatively, pulse shapers have been demonstrated which rely on splitting the pulse spectrally using prisms or gratings and applying a variable phase to each spectral component. When all the components are recombined to recreate the ultrashort pulse the pulse shape is modified, but the modulation effect is uniform across the beam.

It is possible to create a linear delay in the pulse front across a beam (a pulse front tilt) using a combination of prisms and/or gratings.

The invention instead allows more complex two dimensional spatial manipulation of (if desired) just the pulse front across a beam or (if desired) both the phase and pulse fronts.

The applicant has proposed a dual adaptive optics approach for correcting extreme spherical aberration when fabricating deep in the bulk of diamond with a Ti:Sapphire laser, as disclosed in R. D. Simmonds, P. S. Salter, A. Jesacher and M. J. Booth: Optics Express, 19 p.24122 (2011). There is a large refractive index mismatch between the lens immersion medium (oil n=1.52) and the diamond (n=2.4). The continuous shape provided by a DM is proposed to be used for the bulk of the correction of lens aberration, and an SLM is proposed for fine tuning the DM function, particularly for the lens edges. The DM is suggested to cope significantly better with the steep phase gradients required at the edge of the pupil as it is continuous, as opposed to the SLM which would be corrupted by imperfect phase wrapping.

However, there is no disclosure or suggestion of independent phase front and pulse front control.

The invention can also be employed in a laser fabrication system, as explained with reference to FIG. 9, which shows how different paths through the objective lens are focused with different correction approaches. In all three images, the pulse front is shown as 70 and the phase front is shown as 72.

Without any adaptive optics correction as shown in the left image, the refractive index mismatch leads to the rays focussing to different points along the optic axis. There is also a propagation time delay in the focussing as the marginal rays have to traverse a greater distance through the diamond. The pulses corresponding to each ray reach the focus at a different time and the pulse is effectively stretched.

As shown in the central image, an SLM may correct the phase aberration introduced by the refractive index mismatch by changing the phase front entering the lens, such that all rays focus to a common point, but there will still exist a time delay for marginal rays as the SLM does not affect the pulse front.

As shown in the right image, by additionally using the DM, the system corrects the full optical path length such that the rays focus to a common point with no time delay.

The invention is of use generally for focusing through a boundary separating materials of differing refractive index. With no correction there is a loss of spatial and temporal resolution. The SLM improves the spatial but not temporal resolution through modification of just the phase front. The DM modifies both the phase and pulse front which can improve both the spatial and temporal resolution.

This type of refractive index mismatch problem arises in many fields, for example including microscopy when focusing through an immersion objective, through a cover glass or into a specimen mounting medium.

A most basic pulse shaping that can be implemented by the system of the invention is pulse front tilt. The phenomenon of pulse front tilt has been shown to lead to peculiar directional effects in fabrication. Pulse front tilt relates to there being a linear time delay in the pulse front when traversing the beam. When using direct laser writing to create linear structures in transparent substrates, the fabrication effects are different along the two directions parallel and anti-parallel to the pulse front tilt.

Linear phase gradients on the SLM can be used to control phase front tilt in fabrication. As explained above, the SLM does not affect the pulse front, which remains approximately flat. The linear phase gradient on the SLM actually appears as a blazed grating with modulation depth 2π. In the focal plane of the objective the focus is shifted. Rays reaching the focus from opposite sides of the objective travel different distances, so arrive at different times (pulse front tilt). The DM then corrects for the optical path length. Thus a linear phase gradient on the DM also imposes a linear tilt of the pulse front and there is no delay for rays reaching the focus from different points in the objective.

Using large phase gradients on SLM (blazed gratings with short pitch), it is possible to switch on and off directional effects when writing lines. Specifically, the fabrication when writing in one direction is of type 1 (waveguide modification) while in the opposite direction it is type 2 (birefringent nanogratings). By reversing the phase gradient on the SLM the directional effect is reversed, symptomatic of a reversed pulse front tilt.

Another use of the system of the invention is for propagation time difference (PTD) compensation of dispersion in lenses and specimens.

Typically, microscope objectives enable tight focussing of light. Unfortunately they are not typically designed for use at wavelengths around 800 nm (or more generally above 700 nm or below 450 nm) where many ultrafast lasers operate. Furthermore, ultrafast lasers are also often tunable over large wavelength ranges, and shorter pulses have wide spectral bandwidths. Therefore in the vast majority of cases, the dispersion compensation in the lens will not be not perfect.

If there is dispersion in the lens, the group velocity and phase velocity differ. Thus the pulse front and phase front travel at different speeds. Importantly this creates a propagation time difference (PTD) for parts of the pulse propagating through the centre and edge of the lens. This can lead to a temporal broadening of the pulse in the focal plane and a loss of spatial resolution.

This can be corrected by applying a spatial distortion to the pulse front across the beam to counter the PTD by using the arrangement of the invention. A flat phase front can be maintained as required for a diffraction limited focus. Ideally this could be run in closed loop using a feedback metric based on a suitable nonlinear phenomenon such as multi-photon fluorescence.

FIG. 10 shows the focusing of an ultrashort pulse with a lens not perfectly compensated for dispersion.

In FIG. 10(a), the dispersion causes the group velocity and phase velocity to differ. The different thickness of glass as a function of radius leads to a radially dependent propagation time delay for parts of the pulse at the focus. FIG. 10(b) shows how the dispersion also introduces a radially dependent chirp. For pulses of length around 50 fs, the PTD is considered more detrimental to the focus than the chirp. The effect in FIG. 10(a) can be countered using the DM and SLM in tandem to exactly remove the radially dependent PTD, as shown in FIG. 10(c).

There are known methods of focussing ultrashort pulses that either avoid or statically compensate the effect of PTD. These include the use of parabolic mirrors, refractive lenses, or specifically designed hybrid high NA lenses incorporating appropriate compensation. These compensation methods only provide static correction for PTD arising in the lens, which is typically designed for focussing in air. Of course, this is rarely the case in microscopy or laser fabrication and often it is desirable to focus inside a specimen (or a fabrication substrate, such as the diamond discussed above). Then dispersion within the specimen should also be considered, as this will create an alternate radially dependent PTD for the pulse.

The system of the invention can thus be used to compensate for this effect to reduce temporal broadening in the focus, and the controller can apply settings according to the particular use of the laser pulses, in an adaptive manner.

The system of the invention can be extended with additional functionality: For example, the system can include spectral pulse shaping as shown in FIG. 11. The system as described above is represented as 90, and a spectral pulse shaper 92 is provided at the input (although it could be at the output) to the system 90, comprising two gratings 94 and either a SLM or DM between the gratings. This is used to offer a higher degree of control over the temporal characteristics of the pulse. The gratings can be implemented instead as prisms.

In this arrangement, the pulse shaper 92 comprising the linear SLM/DM +grating/prism pair provides temporal optimisation of the pulse across the beam, whereas the system 90 of the invention comprising the 2D LCSLM coupled to the 2D DM can provide spatial pulse front manipulation. The pulse shaper 92 can be situated either before or after the system 90.

Space time focussing is a known approach currently applied with spectral pulse shapers. Again this approach can be applied to offer extra degrees of freedom.

The characterisation device 62 described above with reference to FIGS. 7 and 8 (comprising a wavefront sensor and a unit for temporal measurement of the pulse) can be combined with the full pulse control system of FIG. 11 to result in the system shown in FIG. 12, in order to enable optimum feedback control.

The characterization device 62 can also be placed at the input to the other control devices, to permit open-loop control of the system. It is also possible for the characterization device to be placed between the pulse control system 92 and the wavefront/pulsefront modulation system 90 of the invention.

The simplest implementation of closed loop control of the pulse front control scheme of the invention is to use indirect feedback of the pulse properties. The metric used could be any non-linear phenomenon related to the pulse duration in the focal plane of a focusing objective, such as for example, two-photon fluorescence or supercontinuum emission from the plasma generated during microfabrication. The pulse front control would be varied to optimise the metric ensuring the shortest possible duration of the pulse at that point of the system. This could also be integrated with some direct feedback of the pulse characteristics as shown in FIGS. 7, 8 and 12.

Pulse front shaping can also be applied within the laser cavity. Recently it has been shown that a spectral pulse comprising a grating and DM inside an ultrafast cavity is useful for control over the output pulse characteristics. This is disclosed in N. K. Metzger, W. Lubeigt, D. Burns, M. Griffith, L. Laycock, A. A. Lagatsky, C. T. A. Brown, and W. Sibbett: Optics Express, 18, p8123 (2010).

Modification of the pulse front in the cavity using the pulse front shaper described above may lead to situations where there is a better interaction of the pulse with the gain medium to improve the performance of the laser.

As outlined above, the laser can be a femtosecond pulsed laser, for example with an output wavelength of around 800 nm and a pulse length of around 100 fs. Alternatively, the laser can be a femtosecond pulse fibre laser with a wavelength of around 1000-1100 nm. More generally, the laser can be any short pulsed laser. Femtosecond laser fabrication methods are becoming increasing popular for three-dimensional microfabrication.

The invention can be applied to any fields using ultrashort pulses. In addition to the examples above, data storage and optical trapping applications can make use of the invention as well as systems for the control of lattice responses and multidimensional nonlinear spectroscopy systems.

Various other modifications will be apparent to those skilled in the art.

1. A method of controlling the shape of an optical pulse, comprising:
controlling the shape of the phase front of the pulse across a two dimensional area using a first control device which does not significantly alter the pulse front shape;
controlling the shape of the phase front and the shape of the pulse front of the pulse across a two dimensional area using a second control device;
wherein the first and second devices are controlled such that the combined effect on the phase front results in a desired overall phase front control and the second device provides a desired overall pulse front control.

2. A method as claimed in claim 1, comprising imaging the first control device onto the second control device using an optical lens system.

3. A method as claimed in claim 1, wherein the first control device varies the phase of the pulse by an amount within a range of 0 to 2π and the second control device varies the phase with a maximum phase change greater than 2π.

4. A method as claimed in claim 3, wherein the first control device has a wrapped phase function.

5. A method as claimed in claim 1, wherein the first and second devices are controlled such that their effect on the phase front is cancelled so that only pulse front control is implemented.

6. A method as claimed in claim 1 further comprising performing pulse characterisation in respect of the controlled optical pulse and using this characterisation to adapt the controlling steps.

7. A system for optical pulse shaping of an optical pulse, comprising:
a first control device for controlling the shape of the phase front of the pulse across a two dimensional area which does not significantly alter the pulse front shape;
a second control device for controlling the shape of the phase front and the shape of the pulse front of the pulse across a two dimensional area; and
a controller, which is adapted to control the first and second devices such that the combined effect on the phase front results in a desired overall phase front control and such that the second device provides a desired overall pulse front control.

8. (originally filed) A system as claimed in claim 7, comprising an optical lens system for imaging the first control device onto the second control device.

9. A system as claimed in claim 7, wherein the first control device has a phase function which varies the phase of the pulse by an amount within a range of 0 to 2π and the second control device has a phase function which varies the phase with a maximum phase change greater than 2π.

10. A system as claimed in claim 9, wherein the first control device has a wrapped phase function.

11. A system as claimed in claim 7, wherein the first control device comprises a liquid crystal phase-only spatial light modulator or a pixellated mirror device.

12. A system as claimed in claim 7, wherein the second control device comprises a membrane deformable mirror.

13. A system as claimed in claim 7, further comprising a pulse characterisation unit which provides information to the controller.

14. A system as claimed in claim 13, wherein the pulse characterisation unit is for characterising the shaped optical pulse, and the system comprises a feedback system providing the controller with the pulse characterisation information.

15. A system as claimed in claim 7, further comprising a spectral pulse shaping unit for providing temporal control of the pulse.
